(19) United States
(12) Patent Application Publication
(10) Pub. No.: US 2019/0301671 A1
(43) Pub. Date: Oct. 3, 2019

(54) Mobile Phone Clip and Pet Treat Holder

(71) Applicant: Model Citizen Pet, Inc., Florence, AL (US)

(72) Inventor: Carter McGuyer, Muscle Shoals, AL (US)

(73) Assignee: Model Citizen Pet, Inc., Florence, AL (US)

(21) Appl. No.: 16/372,094

(22) Filed: Apr. 1, 2019

Related U.S. Application Data
(60) Provisional application No. 62/651,303, filed on Apr. 2, 2018.

(51) Int. Cl. F16M 13/02; A01K 15/02; H04B 1/3827

(52) U.S. Cl. CPC F16M 13/022; A01K 15/02; A45F 2005/002; A45F 2200/05; H04B 1/3827

(57) ABSTRACT

The present disclosure is a device that has a substantially cuboidal main body. Further, the device has two arcuate projecting prongs integral with one end of the substantially cuboidal main body and configured to grasp a pet treat and two legs integral with an opposing end of the substantially cuboidal main body and configured to grasp an end of a handheld device.

### CROSS-REFERENCE TO RELATED APPLICATION

This application claims priority to U.S. Provisional Application Ser. No. 62/651,303 entitled Mobile Phone Clip and Pet Treat Hole and filed on Apr. 2, 2018, which is incorporated herein by reference.

### BACKGROUND

Individuals often desire to take pictures of their pets, e.g., their dogs, with their mobile device, e.g., their cellular phones. This often proves difficult because the pet may or may not want to sit or stand in a still position so that the picture can be taken. Notably, getting an animal to sit in one still position so that a photograph can be taken may seem impossible.

### SUMMARY OF THE DRAWINGS

The disclosure can be better understood referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a perspective view of a mobile phone clip and pet treat holder in accordance with an embodiment of the present disclosure.

FIG. 2 is a side view of the mobile phone clip and pet treat holder of FIG. 1.

FIG. 3 is a front view of the mobile phone clip and pet treat holder of FIG. 1.

FIG. 4 is a top view of the mobile phone clip and pet treat holder of FIG. 1.

FIG. 5 is a bottom view of the mobile phone clip and pet treat holder of FIG. 1.

FIG. 6 is a perspective view of the mobile phone clip and pet treat holder of FIG.

FIG. 7 is a side view of the mobile phone clip and pet treat holder of FIG. 1.

FIG. 8 is diagram showing an individual taken a photograph of a dog using the mobile phone clip of FIG. 1.

### DETAILED DESCRIPTION

This present disclosure relates to a mobile phone clip and pet treat holder. The present disclosure describes a device designed for coupling to a top portion of a mobile phone on one end and grasping a pet treat on another end. In use, one can couple the mobile phone clip and pet treat holder to a mobile phone, insert a pet treat, and attempt to take a picture of his/her pet. The mobile phone clip and pet treat holder displays the pet treat to the pet, so the pet looks at the mobile phone while one takes a picture of the pet.

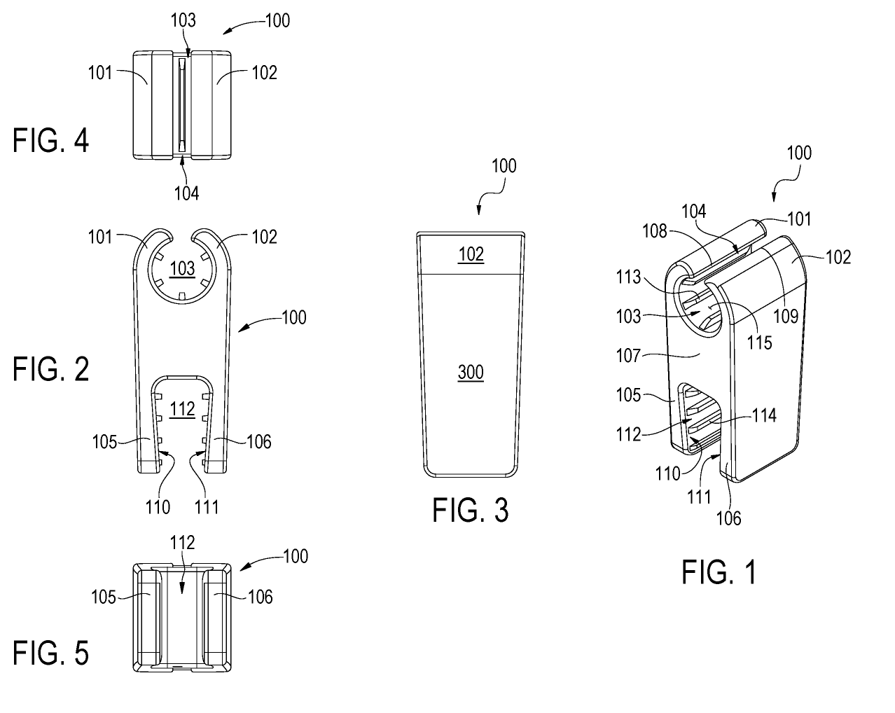

FIG. 1 is a perspective view of a mobile phone clip and pet treat holder 100 in accordance with an embodiment of the present disclosure. In one embodiment, the clip 100 is made of a flexible material, e.g., silicone. However, it may be made of other materials in other embodiments.

The mobile phone clip and pet treat holder 100 comprises on one end two arcuate projecting prongs 101 and 102. The arcuate projecting prongs 101 and 102 extend from a substantially cuboidal main body member 107. The arcuate projecting prongs 101 and 102 curve inward one toward the other and form a circular channel 103 that extends from one side of the clip 100 to the other, Note that in one embodiment, the channel 103 is circular. However, it may be other shapes in other embodiments. The arcuate projecting prongs 101 and 102 do not meet at the apex of the circular channel 103. Instead, ends 108 and 109 of the arcuate projecting prongs 101 and 102 define a slotted opening 104 in which to insert a pet treat (not shown). Further, an inside surface 115 of the circular channel 103 comprises a plurality of lateral protrusions 113 for grasping a pet treat (not shown), as described further herein.

The mobile phone clip and pet treat holder 100 further comprises two legs 105 and 106 that extend from an opposing side of the substantially cuboidal main body member 107. The legs 105 and 106 are substantially straight; however, an inside surface 110 and 111 of each respective leg 105 and 106 each extends angularly inward toward one another. The angularly extending inside surfaces 110 and 111 form a trapezoidal-shaped channel 112 that extends from one side of the clip 100 to the other side. In the trapezoidal-shaped channel 112 is a plurality of laterally-extending protrusions 114 for grasping a mobile phone (not shown) or tablet (not shown), which is described further herein.

As noted hereinabove, the clip 100 is made tip of a flexible material, e.g., silicone. Due to the flexible nature of the material making up the clip 100, a user may slightly separate the legs 105 and 106 and place the legs 105 and 106 on a top end of a mobile phone or tablet so that the trapezoidal-shaped channel 112 snugly grasps the mobile phone or tablet. Further, due to the flexible nature of the material making up the clip 100, the user may slightly separate the protrusions 101 and 102 and place a pet treat (not shown) within the circular channel 103.

With the clip 100 coupled to the phone (not shown) and the pet treat (not shown) displayed to a pet (not shown), the user may then take a photograph of the pet using the mobile phone or tablet. While taking the photograph, the pet treat inserted within the circular channel 103 is likely to keep the attention of the pet while the photo is being taken, thus ensuring that the pet remain substantially still and looking at the pet treat while the photograph is being taken.

FIG. 2 depicts a side view of the mobile phone clip and pet treat holder 100. FIG. 2 depicts the circular channel 103 formed by the arcuate projecting prongs 101 and 102. The circular channel 103 grasps a pet treat (not shown), as discussed above.

Further, FIG. 2 depicts the trapezoidal-shaped channel 112 formed by the legs 105 and 106. The inside surfaces 110 and 111 of the legs 105 and 106, respectively, are formed at slight angles so that the surfaces 110 and 111 are closer together at the end of the clip 100 The trapezoidal shape of the channel 112 formed by the angularly formed surfaces 110 and 111 ensures that the clip 100 firmly grasps the top end of a mobile phone (not shown) or tablet (not shown).

FIG. 3 depicts a side view of the mobile phone clip and pet treat holder 100. As shown, the arcuate projecting prong 102 extends from a planar surface 300 of the mobile phone clip and pet treat holder. The arcuate projecting prong 102 and the arcuate projecting prong 101 (FIG. 1) bow inward thereby creating a circular channel 103 (FIG. 1) in which a pet treat can be grasped.

FIG. 4 depicts a top view of the mobile phone clip and pet treat holder 100. FIG. 4 shows the arcuate projecting prongs 101 and 102. The arcuate projecting prongs 101 and 102 do not come together in the middle, Instead, the ends of the arcuate projecting prongs form a slotted opening 104 providing access to the circular channel 103.

In this regard, a pet treat (not shown) may be inserted in and held by the circular channel 103. Thus, one can use the mobile phone clip and pet treat holder 100 to distract a pet with the pet treat while the individual is taking a picture of his/her pet.

FIG. 5 is a bottom view of the mobile phone clip and pet treat holder 100. Notably, FIG. 5 shows the legs 105 and 106. The legs 105 and 106 form the trapezoidal-shaped channel 112. The trapezoidal-shaped channel 112 is configured to receive and grasp the end of a mobile phone (not shown) or tablet (not shown), as described above.

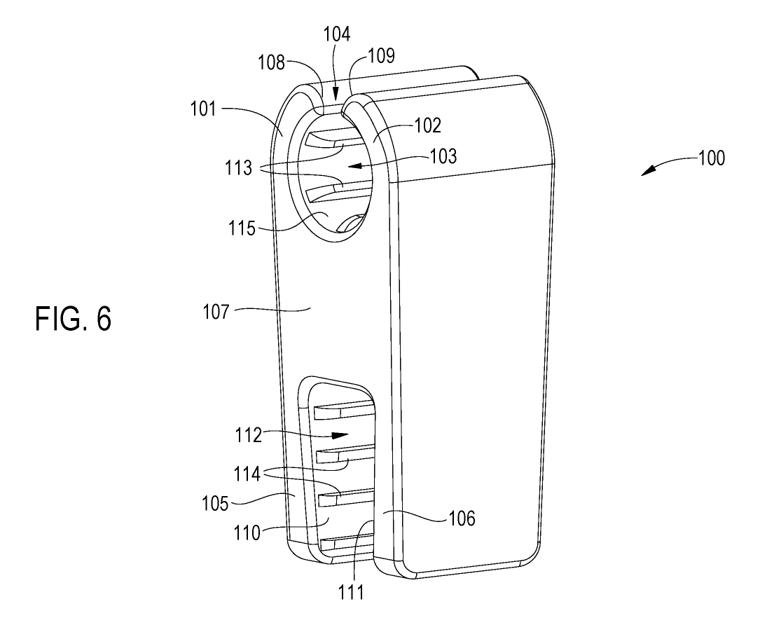

FIG. 6 depicts a perspective view of the mobile phone clip and pet treat holder 100. On one end of the mobile phone clip and pet treat holder 100 is a set of arcuate projecting prongs 101 and 102 that extend from a substantially cuboidal main body 107 of the mobile phone clip and pet treat holder 100. The arcuate projecting prongs 101 and 102 bend outwardly creating a circular channel 103. Further, the arcuate projecting prongs 101 and 102 do not come together on their ends 108 and 109, respectively. The ends 108 and 109 form a slotted opening 104. In one embodiment, the mobile phone clip and pet treat holder 100 is made of a flexible material like silicone. Thus, one can insert a pet treat in the circular channel 103 that is grasped by the lateral protrusions 113. The circular channel 103 and the lateral protrusions 113 hold a pet treat in place while one takes a picture of his/her pet.

The mobile phone clip and pet treat holder 100 further comprises two legs 105 and 106 that extend from an opposing side of the substantially cuboidal main body member 107. The legs 105 and 106 are substantially straight; however, an inside surface 110 and 111 of each respective leg 105 and 106 extends angularly inward toward one another. The angularly extending inside surfaces 110 and 111 form a trapezoidal-shaped channel 112 that extends from one side of the clip 100 to the other side. In the trapezoidal-shaped channel 112 is a plurality of laterally-extending protrusions 114 for grasping a mobile phone (not shown) or tablet (not shown), which is described further herein.

Thus, in operation, the trapezoidal-shaped channel 112 grasps the top end of a mobile phone (not shown). The circular channel 103 and the arcuate projecting prongs 101 and 102 grasp a pet treat. The user points the mobile phone at his/her pet, and the pet is mesmerized by the pet treat long enough for the individual to take a photograph.

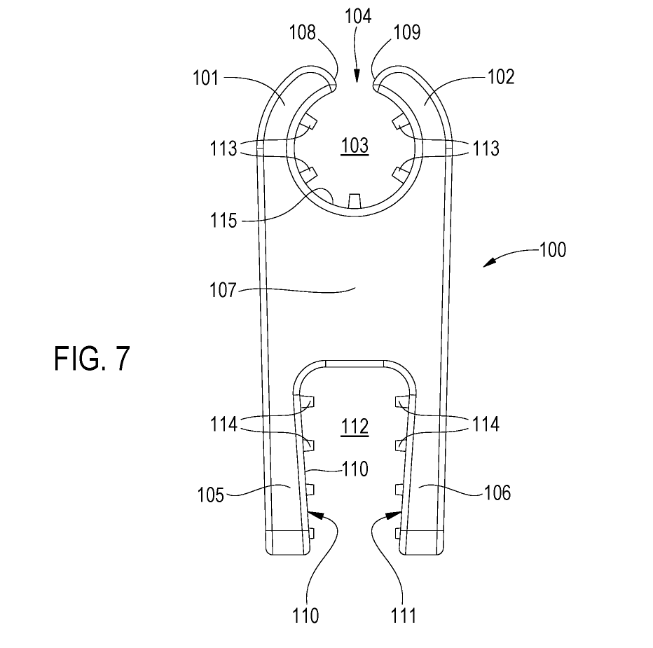

FIG. 7 depicts a side view of the mobile phone clip and pet treat holder 100, The circular channel 103 is formed by the arcuate projecting prongs 101 and 102. Further, ends 108 and 109 of the arcuate projecting prongs 101 and 102 do not come together in the middle forming a slotted opening 104. Thus, one can insert a pet treat (not shown) into the circular channel 103 through the slotted opening 104.

Further, the trapezoidal-shaped channel 112 is formed by the legs 105 and 106, The inside surfaces 110 and 111 of the legs 105 and 106, respectively, are configured at slight inward angles so that the surfaces 110 and 111 are closer together at the end of the clip 100. The trapezoidal shape of the channel 112 formed by the angularly formed surfaces 110 and 111 grasps the top end of a mobile phone (not shown) or tablet (not shown).

Thus, in operation, the trapezoidal-shaped channel 112 grasps the top end of a mobile phone (not shown). The circular channel 103 and the arcuate projecting prongs 101 and 102 grasp a pet treat. The user points the mobile phone at his/her pet, and the pet is mesmerized by the pet treat long enough for the individual to take a photograph.

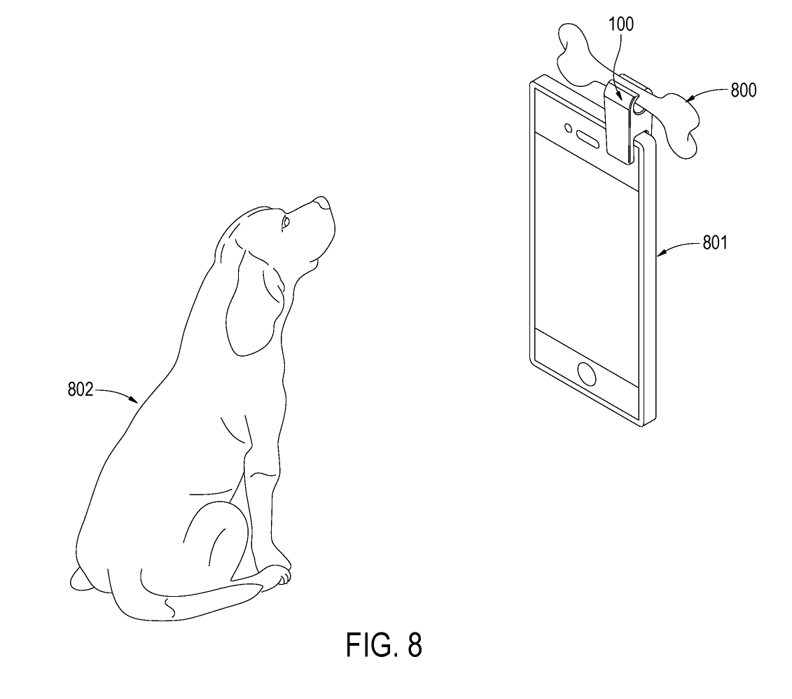

FIG. 8 shows the mobile phone clip and pet treat holder 100 in operation. The mobile phone clip and pet treat holder 100 grasps a pet treat 800. Further, the mobile phone clip and pet treat holder 100 grasps a mobile phone 801.

In operation, a user couples the mobile phone clip and pet treat holder 100 to the mobile phone 801. Further, the user inserts a pet treat into the mobile phone clip and pet treat holder 100. The user points the camera (not shown) of the mobile phone 801 at a pet 802. The pet 802 looks at the treat 800 while the user takes a photograph of the pet 802, thus making for a forward-facing photograph of the pet 802.

What I claim is:

1. A device, comprising:
a substantially cuboidal main body;
two arcuate projecting prongs integral with one end of the substantially cuboidal main body and configured to grasp a pet treat; and
two legs integral with and extending from an opposing end of the substantially cuboidal main body and configured to grasp an end of a handheld device.

2. The device of claim 1, wherein the two arcuate projecting prongs do not come together on their ends forming a slotted opening through which the pet treat can be inserted.

3. The device of claim 2, wherein the two arcuate projecting prongs form a substantially circular channel.

4. The device of claim 3, wherein the substantially circular channel comprises lateral protrusions.

5. The device of claim 1, wherein each leg comprises an inner surface.

6. The device of claim 5, wherein the inner surfaces traverse at an angle so that ends of the legs are closer together than the tops of the legs.

7. The device of claim 6, wherein the inner surfaces comprise lateral protrusions.

8. A device, comprising:
two arcuate projecting prongs configured for grasping a pet treat; and
two legs opposite the two arcuate projecting prongs configured for grasping an end of a handheld device.
